(19) United States
(12) Patent Application Publication
(10) Pub. No.: US 2017/0300751 A1
(43) Pub. Date: Oct. 19, 2017

(54) SMART HISTORY FOR COMPUTER-VISION BASED SECURITY SYSTEM

(71) Applicant: Lighthouse Al, Inc., Palo Alto, CA (US)

(72) Inventors: Alexander William Teichman, Palo Alto, CA (US); Hendrik Dahlkamp, Palo Alto, CA (US)

(21) Appl. No.: 15/132,578

(22) Filed: Apr. 19, 2016

(51) Int. Cl. G06K 9/00; H04N 7/18

(52) U.S. Cl. CPC G06K 9/00711; H04N 7/183; G06K 2009/00738

(57) ABSTRACT

A method for analyzing a video captured by a security system. The method includes obtaining a video of a monitored environment and detecting an occurrence of an event in the video of the monitored environment. Detecting the occurrence of the event includes identifying the presence of a foreground object in the video of the monitored environment and classifying the foreground object. The method further includes tagging the occurrence of the event in the video with the foreground object classification and generating an event history video from the video of the monitored environment, including resampling the video of the monitored environment, the resampling including applying a first event-specific frame drop rate to segments of the video of the monitored environment that include the foreground object, based on the tagging, and applying at least one other frame drop rate to other segments of the video of the monitored environment.

### BACKGROUND

Computer vision may be used by security systems for monitoring and securing environments. Videos of events occurring in a monitored environment may be recorded for a later review.

### SUMMARY

In general, in one aspect, the invention relates to a method for analyzing a video captured by a security system, including obtaining the video of a monitored environment and detecting an occurrence of an event in the video of the monitored environment. Detecting the occurrence of the event includes identifying the presence of a foreground object in the video of the monitored environment and classifying the foreground object. The method further includes tagging the occurrence of the event in the video with the foreground object classification and generating an event history video from the video of the monitored environment, including resampling the video of the monitored environment, the resampling including applying a first event-specific frame drop rate to segments of the video of the monitored environment that include the foreground object, based on the tagging, and applying at least one other frame drop rate to other segments of the video of the monitored environment.

In general, in one aspect, the invention relates to a method for analyzing a video captured by a security system, including obtaining the video of a monitored environment and detecting an occurrence of an event in the video of the monitored environment. Detecting the occurrence of the event includes identifying the presence of a foreground object in the video of the monitored environment and classifying the foreground object. The method further includes generating an event history video from the video of the monitored environment. Generating the event history video includes generating a set of frames of the event history video. Each frame of the event history video includes the background region, each frame of the event history video corresponds to a time window of the video of the monitored environment, and in at least a frame of the set of frames, a color shift is applied to a portion of the pixels of the frame that are in a region of the frame in which the foreground object was present in the video of the monitored environment during the time window corresponding to the frame. The foreground object is not shown in the frame.

In general, in one aspect, the invention relates to a non-transitory computer readable medium including instructions that enable a system to obtain a video of a monitored environment and detect an occurrence of an event in the video of the monitored environment. Detecting the occurrence of the event includes identifying the presence of a foreground object in the video of the monitored environment and classifying the foreground object. The non-transitory computer readable medium further includes instructions that enable the system to tag the occurrence of the event in the video with the foreground object classification and generate an event history video from the video of the monitored environment including resampling the video of the monitored environment, the resampling including applying a first event-specific frame drop rate to segments of the video of the monitored environment that include the foreground object, based on the tagging, and applying at least one other frame drop rate to other segments of the video of the monitored environment.

In general, in one aspect, the invention relates to a non-transitory computer readable medium including instructions that enable a system to obtain a video of a monitored environment and detect an occurrence of an event in the video of the monitored environment. Detecting the occurrence of the event includes identifying the presence of a foreground object in the video of the monitored environment and classifying the foreground object. The instructions further enable the system to generate an event history video from the video of the monitored environment, including generating a set of frames of the event history video. Each frame of the event history video includes the background region, each frame of the event history video corresponds to a time window of the video of the monitored environment, and in at least a frame of the set of frames, a color shift is applied to a portion of the pixels of the frame that are in a region of the frame in which the foreground object was present in the video of the monitored environment during the time window corresponding to the frame. The foreground object is not shown in the frame.

Other aspects of the invention will be apparent from the following description and the appended claims.

### BRIEF DESCRIPTION OF DRAWINGS

FIG. 1 shows a system in accordance with one or more embodiments of the invention.

FIG. 2A shows an exemplary video of a monitored environment and event tags in accordance with one or more embodiments of the invention.

FIG. 2B shows an exemplary event history video in accordance with one or more embodiments of the invention.

FIGS. 3-5 show flowcharts in accordance with one or more embodiments of the invention.

### DETAILED DESCRIPTION

Specific embodiments of the invention will now be described in detail with reference to the accompanying figures. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

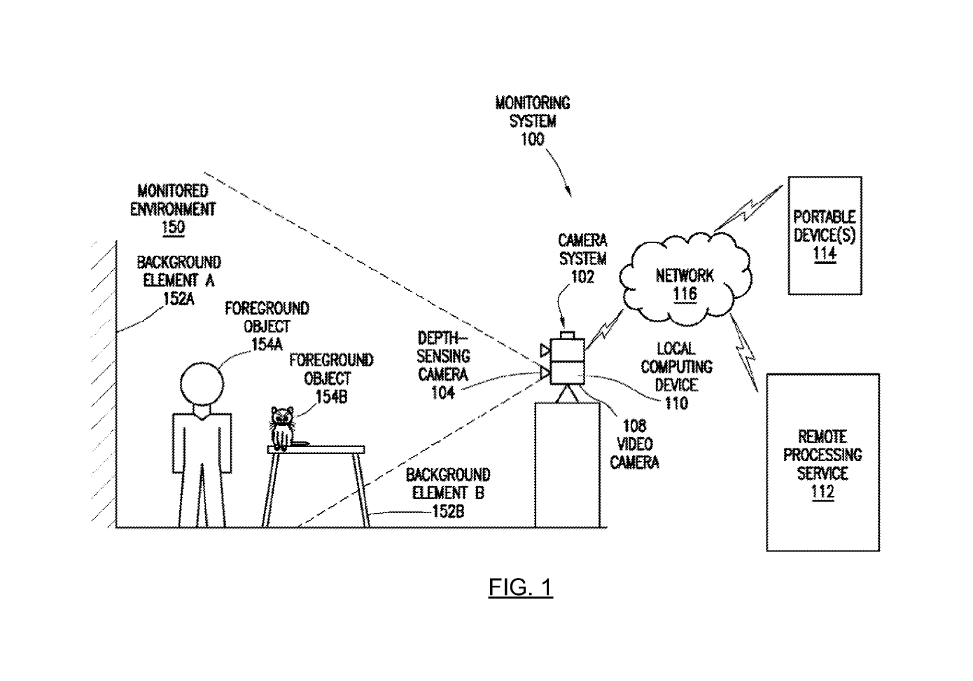

In the following description of FIGS. 1-5, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to a monitoring system used for securing an environment. A monitoring system may detect object movement in a monitored environment, may isolate the moving object(s) from the surrounding environment, and may classify the moving object(s). Based on the classification of the moving object(s) by a classification algorithm, the moving objects may be determined to be, for example, threats, harmless, or unknown. Appropriate actions, such as calling the police, may subsequently be taken.

In one or more embodiments of the invention, the monitoring system generates event history videos of the monitored environment. An event history video may summarize events that have occurred in the monitored environment, for example, throughout a day. An event history video may include multiple segments with differing time scales. For example, segments that are deemed interesting, e.g., when a person is present in the workspace, may be played back in real-time or slightly accelerated. For segments with activity deemed less relevant, e.g., when a pet is present in the workspace, the playback speed may be further accelerated, whereas the playback speed may be highly accelerated when no activity at all is observed in the monitored environment. In one embodiment of the invention, the generation of an event history video may be initiated when the monitoring system is armed. An event history video may further be generated when the monitoring system is disarmed but active, i.e., when the monitoring system observes the monitored environment without taking actions such as, for example, triggering an alarm.

FIG. 1 shows a monitoring system (100) used for the surveillance of an environment (monitored environment (150)), in accordance with one or more embodiments of the invention. The monitored environment may be a three-dimensional space that is within the field of view of a camera system (102). The monitored environment (150) may be, for example, an indoor environment, such as a living room or an office, or it may be an outdoor environment such as a backyard. The monitored environment (150) may include background elements (e.g., 152A, 152B) and foreground objects (e.g., 154A, 154B). Background elements may be actual backgrounds, i.e., a wall or walls of a room. In one embodiment of the invention, the monitoring system (100) may further classify other objects, e.g., stationary objects such as a table (background element B (152B)) as background elements. In one embodiment of the invention, the monitoring system (100) may classify other objects, e.g., moving objects such as a person or a pet, as foreground objects (154A, 154B). The monitoring system (100) may further classify detected foreground objects (154A, 154B) as threats, for example, if the monitoring system (100) determines that a person (154A) detected in the monitored environment (150) is an intruder, or as harmless, for example, if the monitoring system (100) determines that the person (154A) detected in the monitored environment (150) is the owner of the monitored premises, or if the classified object is a pet (154B). In one embodiment of the invention, the monitoring system (100) includes a camera system (102) and a remote computing device (112). The monitoring system, in accordance with an embodiment of the invention, further includes one or more portable devices (114). Each of these components is described below.

In one or more embodiments of the invention, the monitoring system (100) includes a camera system (102). The camera system may include a video camera (108) and a local computing device (110), and may further include a depth sensing camera (104) if the monitored environment is captured and analyzed in three-dimensional space. The camera system (102) may be a portable unit that may be positioned such that the field of view of the video camera (108) covers an area of interest in the environment to be monitored. The camera system (102) may be placed, for example, on a shelf in a corner of a room to be monitored, thereby enabling the camera to monitor the space between the camera system (102) and a back wall of the room. Other locations of the camera system may be used without departing from the invention.

The video camera (108) may be capable of continuously capturing a two-dimensional video of the environment (150). The video camera may be rigidly connected to the other components of the camera system (102). The field of view and the orientation of the video camera may be selected to cover a portion of the monitored environment (150) similar (or substantially similar) to the portion of the monitored environment captured by the depth sensing camera, if included in the monitoring system. The video camera may use, for example, an RGB or CMYG color CCD or CMOS sensor with a spatial resolution of for example, 320×240 pixels, and a temporal resolution of 30 frames per second (fps). Those skilled in the art will appreciate that the invention is not limited to the aforementioned image sensor technologies, temporal, and/or spatial resolutions. Further, a video camera's frame rates may vary, for example, depending on the lighting situation in the monitored environment.

In one embodiment of the invention, the depth-sensing camera (104) is a camera capable of reporting multiple depth values from the monitored environment (150). For example, the depth-sensing camera (104) may provide depth measurements for a set of 320×240 pixels (Quarter Video Graphics Array (QVGA) resolution) at a temporal resolution of 30 frames per second (fps). The depth-sensing camera (104) may be based on scanner-based or scannerless depth measurement techniques such as, for example, LIDAR, using time-of-flight measurements to determine a distance to an object in the field of view of the depth-sensing camera (104). In one embodiment of the invention, the depth-sensing camera (104) may further provide a 2D grayscale image, in addition to the depth-measurements, thereby providing a complete 3D grayscale description of the monitored environment (150). Those skilled in the art will appreciate that the invention is not limited to the aforementioned depth-sensing technology, temporal, and/or spatial resolutions. For example, stereo cameras may be used rather than time-of-flight-based cameras.

In one embodiment of the invention, the volume of the monitored environment (150) is defined by the specifications of the video camera (108) and/or the depth-sensing camera (104). The video camera (108) may, for example, have a set field of view, and the depth-sensing camera (104) may, for example, have a limited minimum and/or maximum depth tracking distance in addition to a set field of view.

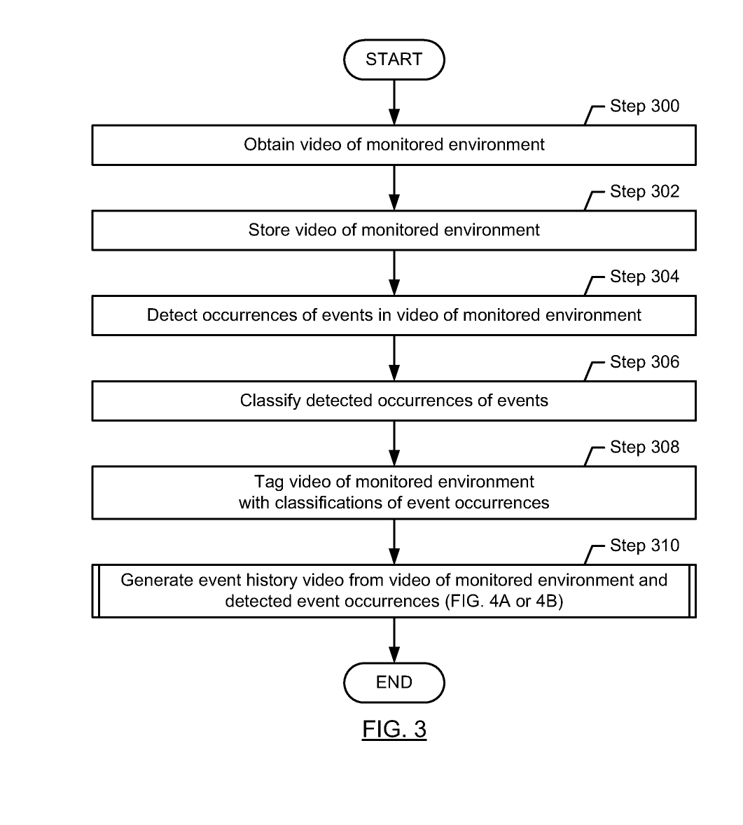

In one embodiment of the invention, the camera system (102) includes a local computing device (110). Any combination of mobile, desktop, server, embedded, or other types of hardware may be used to implement the local computing device. For example, the local computing device (110) may be a system on a chip (SOC), i.e., an integrated circuit (IC) that integrates all components of the local computing device (110) into a single chip. The SOC may include one or more processor cores, associated memory (e.g., random access memory (RAM), cache memory, flash memory, etc.), a network interface (e.g., a local area network (LAN), a wide area network (WAN) such as the Internet, mobile network, or any other type of network) via a network interface connection (not shown), and interfaces to storage devices, input and output devices, etc. The local computing device (110) may further include one or more storage device(s) (e.g., a hard disk, an optical drive such as a compact disk (CD) drive or digital versatile disk (DVD) drive, a flash memory stick, etc.), and numerous other elements and functionalities. In one embodiment of the invention, the computing device includes an operating system (e.g., Linux) that may include functionality to execute the methods further described below. Those skilled in the art will appreciate that the invention is not limited to the aforementioned configuration of the local computing device (110). In one embodiment of the invention, the local computing device (110) may be integrated with the depth sensing camera (104) and/or the video camera (108). Alternatively, the local computing device (110) may be detached from the depth sensing camera (104) and/or the video camera (108), and may be using wired and/or wireless connections to interface with the local computing device (110). In one embodiment of the invention, the local computing device (110) executes methods that include functionality to implement at least portions of the various methods described below (see, e.g., FIGS. 3-5). The methods performed by the local computing device (110) may include, but are not limited to, functionality to identify foreground objects from movement detected in the video and/or depth data provided by the video camera (108) and/or the depth-sensing camera (104), and to send the depth data of the foreground objects to the remote processing service (112).

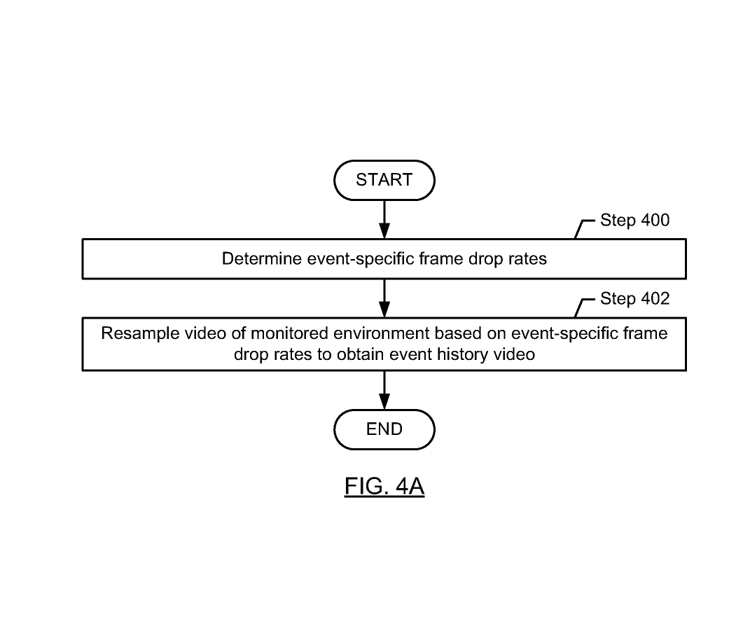

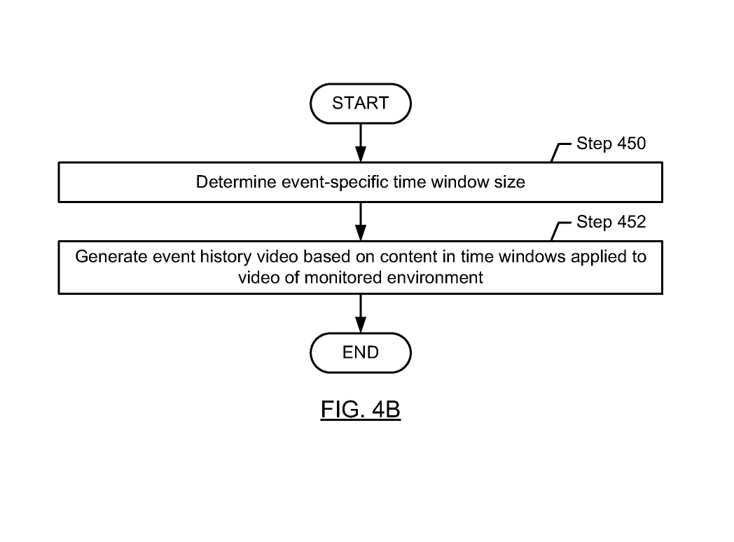

Continuing with the discussion of FIG. 1, in one or more embodiments of the invention, the monitoring system (100) includes a remote processing service (112). In one embodiment of the invention, the remote processing service (112) is any combination of hardware and software that includes functionality to serve one or more camera systems (102). More specifically, the remote processing service (112) may include one or more servers (each including at least a processor, memory, persistent storage, and a communication interface) executing one or more applications (not shown) that include functionality to implement various methods described below with reference to FIGS. 3-5). The services provided by the remote processing service (112) may include, but are not limited to, functionality to: receive and archive streamed video, identify and track foreground objects (154) from the video and/or depth data provided by a camera system (102), and classify identified foreground objects (154). The services provided by the remote processing service may further include additional functionalities to handle foreground objects (154) classified as threats, and to learn the classification of unknown foreground objects (154). In one embodiment of the invention, the remote processing service (112) generates event history videos, as further described below, with reference to FIGS. 3, 4A and 4B.

In one or more embodiments of the invention, the monitoring system (100) includes one or more portable devices (114). A portable device (114) may be a device (e.g., a laptop, smart phone, tablet, etc.) enabling a user of the portable device (114) to interact with the camera system (102) and/or the remote processing service (112). The user may, for example, receive video streams from the camera system, configure, activate or deactivate the camera system, etc. In one embodiment of the invention, the user may employ a portable device to navigate, control and/or view event history videos and/or to configure the generation of event history videos, as described below with reference to FIGS. 3-5.

The components of the monitoring system (100), i.e., the camera system(s) (102), the remote processing service (112) and the portable device(s) (114) may communicate using any combination of wired and/or wireless communication protocols. In one embodiment of the invention, the camera system(s) (102), the remote processing service (112) and the portable device(s) (114) communicate via a wide area network (e.g., over the Internet), and/or a local area network (e.g., an enterprise or home network). The communication between the components of the monitoring system (100) may include any combination of secured (e.g., encrypted) and non-secure (e.g., un-encrypted) communication. The manner in which the components of the monitoring system (100) communicate may vary based on the implementation of the invention.

One skilled in the art will recognize that the monitoring system is not limited to the components shown in FIG. 1. For example, the depth-sensing camera may be based on different underlying depth-sensing technologies, and/or the camera system may include additional components not shown in FIG. 1, e.g., infrared illuminators providing night vision capability, ambient light sensors that may be used by the camera system to detect and accommodate changing lighting situations, etc. Further, a monitoring system may include any number of camera systems, any number of remote processing services, and/or any number of portable devices. In addition, the monitoring system may be used to monitor a variety of environments, including various indoor and outdoor scenarios.

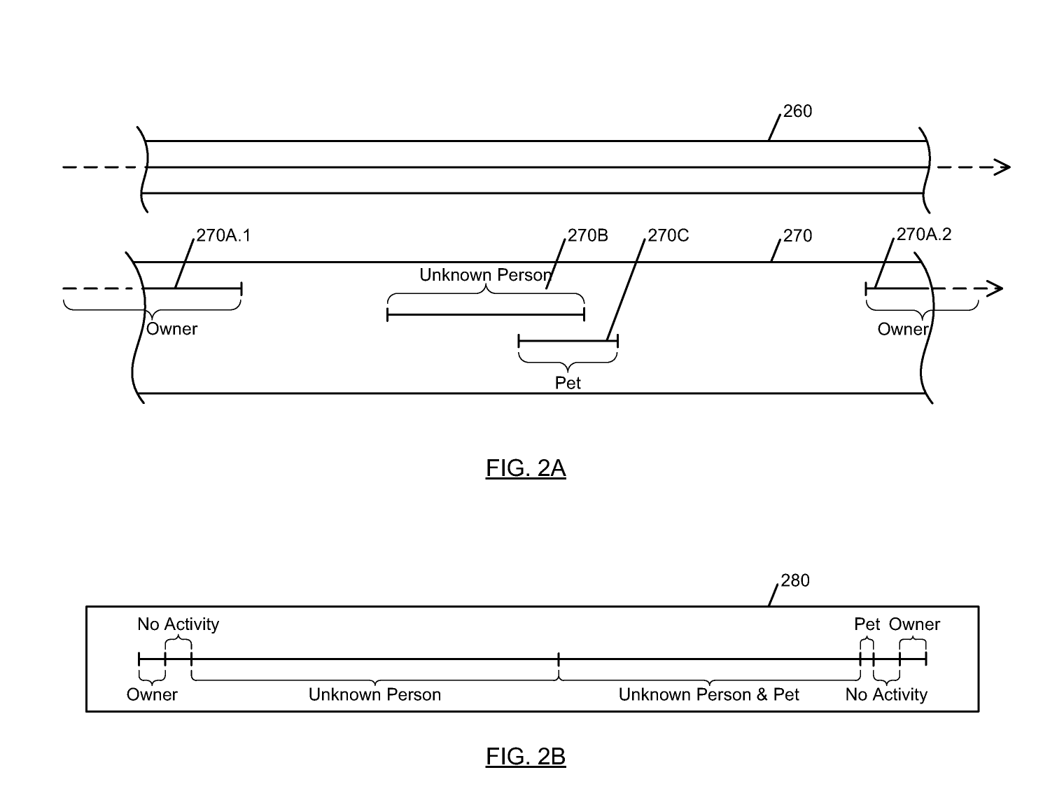

FIG. 2A shows an exemplary video of a monitored environment and event tags in accordance with one or more embodiments of the invention. The video of the monitored environment (260) may be obtained continuously, for example, whenever the monitoring system is armed, or when the monitoring system is disarmed but active. The event tags (270) may be obtained from the video of the monitored environment (260) either in real-time or near-real-time as the video is obtained, or at a later time.

The video of the monitored environment (260), in accordance with an embodiment of the invention, is obtained from the video camera (108) of the camera system (102) and may be transmitted via the network (116) to the remote processing service (112), where it may be archived in a video file, e.g., on a hard disk drive. The archiving may alternatively be performed locally by the local computing device (110). The video of the monitored environment may be archived, for example, using a ring buffer-like storage with a capacity sufficient to store video data for the desired time span. To increase the amount of video data to be stored, the video of the monitored environment may be resampled and/or compressed using video compression algorithms (e.g., MPEG-1, 2, or 4, etc.).

The event tags (270), in accordance with an embodiment of the invention, label occurrences of events in the video (260). The event tags may be generated based on an analysis of the video of the monitored environment (260), obtained from the video camera (108), or, if available, based on an analysis of depth data recordings from the depth-sensing camera (104). An event, as illustrated in the exemplary event tags (270) of FIG. 2A, may be any kind of activity detected in the video of the monitored environment, i.e., movement of foreground objects in the monitored environment (150). The monitoring system (100), in accordance with an embodiment of the invention, classifies the foreground objects detected in the video of the monitored environment. Each occurrence of a foreground object may result in the generation of an event tag, based on the classification of the detected foreground object. Classes of event occurrences, based on detected foreground objects, may include, but are not limited to, known persons, e.g. the owner, unknown persons and pets. A separate event class may further exist for unknown foreground objects. In the exemplary event tags of FIG. 2A, the homeowner is initially active in the monitored environment. The reported event class is “owner” (270A.1). Subsequently, the owner disappears and no activity is detected. Later (moving to the right in FIG. 2A), the housekeeper enters the monitored environment. The monitoring system is unable to identify the person and therefore classifies the housekeeper as an “unknown person” (270B). As the housekeeper is active in the monitored environment, the owner's cat becomes active and remains active until after the housekeeper has left. The cat is classified as a “pet” (270C). Eventually the owner returns back home and is active in the monitored environment. The owner is again classified as the “owner” (270A.2). The events shown in the exemplary event tags of FIG. 2A may be typical for a day where a homeowner leaves the house in the morning and returns in the evening.

In one or more embodiments of the invention, the monitoring system (100) may be able to classify a variety of foreground objects. For example, the monitoring system may be able to distinguish between a human and a pet, based on the size and other characteristics of observed foreground objects. Further the monitoring system may also be able to distinguish the owner from another person moving within the monitored environment. The distinction may be performed based on visual features and/or using other identifying features such as WiFi and/or Bluetooth signals of the owner's portable device (114). Accordingly, a variety of foreground object classifications that may be used for event tagging may exist.

The event tags (270) may be stored in volatile and/or non-volatile memory of the remote processing service (112). Alternatively, if a foreground object classification is performed locally by the local computing device, the event tags may be stored in volatile and/or non-volatile memory of the local computing device (110). The event tags (270) may be stored separately from the video of the monitored environment (260) for example by identifying start frames or start times and end frames or end times of event occurrences in the video of the monitored environment (260) or by storing individual frame numbers of the video of the environment (260). Alternatively, the video of the monitored environment (260) itself, e.g., individual video frames or sets of frames, may be tagged with labels indicating the detected classes of foreground objects found in the frames of the video.

FIG. 2B shows an exemplary event history video (280) in accordance with one or more embodiments of the invention. An event history video in accordance with one or more embodiments of the invention summarizes events that have occurred over a specified duration. The event history video may, for example, summarize all events starting from the moment when a user activates the monitoring system to the moment when the user deactivates the monitoring system. An event history video may thus provide a summary of the events that have occurred over a particular period of time, for example, during the time that the user had left the house. The exemplary event history video (280) in FIG. 2B is generated from the video of the monitored environment (260) based on the detected events documented using event tags (270), as shown in FIG. 2A.

In one or more embodiments of the invention, the event history video (280) is a video of the monitored environment, generated from the video (260). The event history video may enable a user to quickly assess events that have occurred. To increase the amount of information provided by the event history video (280) within the limited playback time of the event history video, variable temporal scaling may be applied when generating the event history video (280) from the video (260). For example, for periods during which no activity was observed in the monitored environment, the playback may be highly accelerated, e.g., hours of inactivity in the monitored environment may be displayed within a few seconds. For periods during which events of limited relevance (e.g. a pet being active in the monitored environment) were registered, the playback may be accelerated, although to a lesser degree. In contrast, for periods during which activity deemed relevant is occurring in the monitored workspace, a mild acceleration may be applied only, thus enabling the owner to review these events. The exemplary event history video of FIG. 2B illustrates above-discussed selective playback acceleration. For example, the events attributed to the owner's presence in the monitored environment are highly accelerated because the owner would typically not need to review his own activities. Further, periods of no activity are highly accelerated, to the point that they are almost eliminated. In contrast, the entire period during which the housekeeper is presented in the monitored environment is only mildly accelerated, allowing the owner to review the housekeeper's activities. The period during which only the owner's cat but not the housekeeper is present in the monitored environment is again accelerated to a more significant degree.

As a result, the event history video (280), composed from the segments where variable playback acceleration was applied, is sufficiently short to be reviewed in a limited time, while still showing activities that have occurred with sufficient temporal resolution when necessary.

In one embodiment of the invention, the event history video (280) has a variable length, determined by the combination of events to be included in the event history video. More specifically, in a variable-length event history video, the length of the event history video is governed by factors including, for example, the length of the time interval for which an event history video is to be generated and the classes of events that were detected in that time interval. The details of generating variable-length event history videos are described below with reference to FIGS. 4A and 4B.

In an alternative embodiment of the invention, the event history video (280) has a fixed length that may be pre-specified by a user as part of the configuration of the monitoring system. The length of the event history video may be independent from the length of the time interval for which the event history video is generated and from the classes of events that are detected in that time interval. The degree of playback acceleration may be set such that the combination of the events result in an event history video with the desired length. The details of generating fixed-length event history videos are described below with reference to FIGS. 4A and 4B.

Those skilled in the art will recognize that the invention is not limited to the exemplary video (260), detected events (270) and event history video (280) shown in FIGS. 2A and 2B. Further, a monitoring system in accordance with an embodiment of the invention may include multiple camera systems, each of which may provide a separate video (260) (e.g., one camera system may be set up for monitoring the living room, and a separate camera system may be set up for monitoring the office), may be generated. These multiple videos may be analyzed for occurrences of events and may be used to generate either a single or multiple separate event history videos (280), as described below.

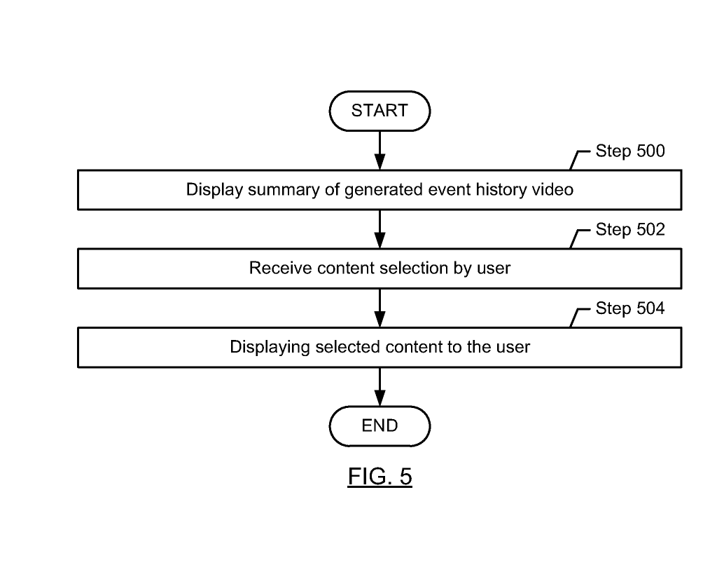

FIGS. 3-5 show flowcharts in accordance with one or more embodiments of the invention. While FIGS. 3, 4A and 4B describe the generation of event history videos, FIG. 5 describes the presentation of generated event history videos to users reviewing the event history videos.

While the various steps in the flowcharts are presented and described sequentially, one of ordinary skill will appreciate that some or all of these steps may be executed in different orders, may be combined or omitted, and some or all of the steps may be executed in parallel. In one embodiment of the invention, the steps shown in FIGS. 3-5 may be performed in parallel with any other steps shown in FIGS. 3-5 without departing from the invention.

Software instructions in the form of computer readable program code to perform embodiments of the technology may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform methods, described in FIGS. 3-5.

FIG. 3 shows a method for generating an event history video that summarizes events that have occurred in a monitored environment during a specified time interval. The specified time interval may begin when a user of the monitoring system activates or arms the monitoring system and may end when the user deactivates or disarms the monitoring system. Circumstances that trigger the starting and stopping of the recording may be configurable, i.e., the administrator may choose in what states of the monitoring system a video may be captured by the video camera and/or the depth sensing camera. The method may be performed by a monitoring system that only includes a single camera system and no remote processing service. In this case, all subsequently described steps may be performed by a local computing device, interfacing with the camera system of the monitoring system. Alternatively, the method may be performed by a monitoring system that includes a camera system and a remote processing service. In this case, the subsequently described steps may be performed by the local computing device and/or by the remote processing service. Those skilled in the art will appreciate that the subsequently described steps may be distributed between the local computing device and the remote processing service. Further, the method may also be performed by a monitoring system that includes multiple camera systems that all interface with a central remote processing service. In this case, the steps may also be performed by the local computing device and by the remote processing service in a distributed manner.

In Step 300, a video of the monitored environment is obtained. The video may be obtained continuously using the monitoring system's video camera. The obtained video of the monitored environment may be processed by the local computing device. Processing of the video of the monitored environment may include resampling and compressing the video. Processing may further include forwarding the video of the monitored environment to the remote processing service. In one embodiment of the invention, obtaining the video includes obtaining three-dimensional (3D) depth data from the monitored environment. The 3D depth data may be obtained from the monitoring system's depth-sensing camera. The obtained 3D depth data, combined with the video of the monitored environment may enable the reconstructions of a full 3D grayscale or color representation of the monitored environment.

In Step 302, the video of the monitored environment is stored. The video may be stored, for example, in a non-volatile storage, e.g. on a hard disk drive, of the local computing device and/or the remote processing service.

In Step 304, occurrences of events are detected. The detection may be performed based on the previously obtained video and/or 3D depth data of the monitored environment. The detection of an occurrence of an event, in accordance with an embodiment of the invention, includes a detection of one or more foreground objects in the video and/or depth data of the monitored environment. The detection may be based on the detection of movement in the video and/or in the depth data. Movement of clusters of pixels in the video and/or the depth data may indicate the movement of objects in the monitored environment. Based on the detection of movement, the monitoring system in accordance with an embodiment of the invention distinguishes foreground objects from the background of the monitored environment. Additional details regarding the distinction of foreground objects from the background of the monitored environment are provided in U.S. patent application Ser. No. 14/813,907 filed Jul. 30, 2015, the entire disclosure of which is hereby expressly incorporated by reference herein.

In one embodiment of the invention, the detection of event occurrences is performed in real-time or near-real time as the video and/or depth data of the monitored environment are received. Alternatively, the detection may be performed at a later time. In one embodiment of the invention, the detection is performed by the local computing device. Alternatively, the detection may be performed by the remote processing service.

In Step 306, the detected occurrences of events are classified. More specifically, the foreground objects, identified and isolated from the background in Step 304, are classified, in accordance with an embodiment of the invention. The classification may assign each foreground object to a particular class. Classes may include, but are not limited to, persons, pets and unknown foreground objects. Classes may further distinguish between different persons, for example between known and unknown persons. A known person may be a person that the monitoring system is capable to identify. The identification may be performed based on one or more features associated with that person. These features may include, for example, appearance, size, known behavioral patterns, including posture and gait. These features may have been learned by the monitoring system. Further these features may include other distinguishable aspects, such as the presence of a uniquely identifiable signal, including Bluetooth and or WiFi signal of a portable device, carried by the person. A known person may further be a person that, the monitoring system may be able to distinguish from other persons, even though the monitoring system does not know the identity of the person. For example, a person wearing a blue sweater that repeatedly appears in the monitored environment may be distinguished from other persons appearing in the monitored environment. Those skilled in the art will recognize that the classification is not limited to a particular type of classes. Classes can be very broad (e.g. a distinction between a foreground object considered a threat and a foreground object considered benign, or a distinction between a person and a pet), or narrower (e.g. distinction of different persons, distinction of dogs from cats, etc.). The classes of foreground objects to be used by the monitoring system for classification purposes may be specified by the user in a setup procedure of the monitoring system. This setup procedure may include providing necessary data to enable a classification algorithm of the monitoring system to reliably perform the classification.

The classification algorithm may be any algorithm capable of distinguishing classes of foreground objects and may include, but is not limited to, linear classifiers, support vector machines, quadratic classifiers, kernel estimators, boosting algorithms, decision trees, deep learning algorithms, and neural networks. In one embodiment of the invention, the classification is performed by the local computing device, executing the classification algorithm.

Features considered by the classification algorithm may include any kind of characteristics that may be captured by the video camera and/or by the depth-sensing camera. These characteristics may include, for example, dimensions (e.g., size and volume of the detected foreground object), color and texture (e.g., for recognition of a person based on clothing), movement (e.g., for recognition of a person based on gait and posture), and/or any other visually perceivable characteristics (e.g., for performing a face recognition).

In one embodiment of the invention, a classification of a detected event occurrence is performed in real-time or near-real time after the event occurrence has been detected. Alternatively, the classification may be performed at a later time. In one embodiment of the invention, the classification is performed by the local computing device. Alternatively, the classification may be performed by the remote processing service.

In Step 308, the video of the monitored environment is tagged with the classifications of the event occurrences, i.e., based on the classifications obtained for the detected foreground objects. Event occurrence tagging may be performed either by tagging individual frames or sets of frames in the video of the monitored environment itself, or alternatively by documenting the occurrence of events in a separate file. This documentation may be based on frame numbers or frame times of either individual frames, or sets of frames marked, for example, by a beginning and an end frame.

In Step 310, an event history video is generated from the video of the monitored environment. The event history video may be generated once the video of the monitored environment and the event tags are available. In another scenario, event history video may be generated, for example, after the recording of the video of the monitored environment has stopped, of upon user request, e.g., when the user request the viewing of the event history video. The details of Step 310 are described in FIGS. 4A and 4B.

FIGS. 4A and 4B show methods for generating the event history video from the video of the monitored environment, based on the classifications of the events in the video of the monitored environment. In FIG. 4A, a method is described, in which the event history video is generated by down-sampling of the video of the monitored environment. In FIG. 4B, a method is described, in which the event history video is generated from newly created frames.

Turning to FIG. 4A, in Step 400, event-specific frame drop rates are determined. A frame drop rate, in accordance with an embodiment of the invention, determines how many frames of a segment of the video of the monitored environment, marked by an event tag, are dropped when the segment is inserted into the event history video. A higher frame drop rate indicates a larger number of frames to be dropped. Accordingly, the frame drop rate may determine to what degree a tagged segment of the video of the monitored environment is shortened. For example, a ten-minute segment of a video of the monitored environment, where nine out of ten frames are dropped, may play back in one minute. Frame drop rates, in accordance with an embodiment of the invention, are determined such that they compensate for differences in frame rates between the video of the monitored environment and the event history video and may further accommodate fluctuating frame rates of the video of the monitored environment.

In one embodiment of the invention, fixed event-specific frame drop rates are used to generate the event history video. For example, only a single frame may be included in the event history video for each minute of inactivity found in the video of the monitored environment, ten frames may be included for each minute of activity tagged as being of limited relevance, and 120 frames may be included for each minute of activity tagged as being of high relevance. Accordingly the resulting event history video may have a variable length. The length of the event history video may depend on, for example, the length of the time interval for which an event history video is to be generated and on the classes of events that were detected in that time interval. For example, the event history video may be very short if no activity at all was detected, whereas the event history video may be considerably longer if activity deemed relevant were detected during the time interval. The fixed event-specific frame drop rates may be user-configurable.

In an alternative embodiment of the invention, variable event-specific frame drop rates may be used to obtain a fixed-length event history video. For example, the user configuring the monitoring system may specify that the desired length of the event history video is to be one minute long, regardless of the length of the time interval for which the event history video is to be generated, and regardless of the types of events detected during that time period. To obtain a fixed-length event history video, only ratios of frame drop rates between the events of various significance, but not absolute frame drop rates may be specified. For example, a ratio 1:10:120 (inactivity:limited relevance:high relevance) indicates that for each frame of “inactivity”, ten frames of event occurrences considered to be of limited relevance and 120 frames of event occurrences considered to be of high relevance are selected. The actual frame drop rates may then be adapted based on the desired length of the event history video and based on the characteristics of the video and detected event tags.

As previously discussed, classes of foreground objects but also the corresponding frame drop rates may be user configurable. Accordingly, a user may decide what time allotment various types of event occurrences receive in the event history video. For example, many users may choose to dedicate significant playback time to foreground objects that pose potential security risks and/or to unknown foreground objects. In contrast, a user who wishes to study his pet's behavior may configure the monitoring system such that significant playback time is dedicated to his pet.

In Step 402, the video of the monitored environment is resampled, based on the event-specific frame drop rates obtained in Step 400. In the resulting event history video, the duration of the various segments of the video of the monitored environment, is modulated by the frame drop rates associated with the tags.

The resampling operation may be performed by the remote processing service, if part of the monitoring system. In monitoring systems that do not include a remote processing service, the resampling may operation may be performed by the local computing device.

The event history video may be stored, for example, by the remote processing service, from where it may be accessible by portable devices.

Turning to FIG. 4B, in Step 450, event-specific time window sizes are determined. An event-specific time window size, in accordance with an embodiment of the invention, determines the length of a time interval in the video of the monitored environment, to be considered for generating a single event history video frame. The length of the video segment of the monitored environment to be considered for generating a single frame of the event history video may be configurable. It may be, for example, a few minutes, hours, days, etc. Generally, a longer time window may result in a more condensed event history video with fewer details being shown because more frames of the video of the monitored environment are considered for the generation of a single frame of the event history video. In contrast, a shorter time window may result in an event history video with more details being shown because fewer frames of the video of the monitored environment are considered for the generation of a single frame of the event history video.

In one embodiment of the invention, fixed event-specific time window sizes are used to generate the event history video. A fixed event-specific time window size may be determined based on the significance of the event. For example, a time window may be comparatively large if only a pet is present in the monitored environment during the time windows, whereas a time windows may be relatively short if a person is present in the monitored environment during the time window. Accordingly the resulting event history video, generated in Step 452, may have a variable length. Specifically, the generated event history video may be longer if events in the monitored environment are considered to be more significant, whereas the event history video may be shorter if events in the monitored environment are considered to be less significant.

The fixed event-specific time window sizes may be user-configurable. Alternatively or additionally, the time windows may be scaled to obtain an event history video of a specified length, analogous to the scaling of the frame drop rates, previously described in Step 400.

In Step 452, an event history video is generated based on events occurring in the video of the monitored environment, during the time windows. The event history video, in accordance with an embodiment of the invention, includes a stationary image of the background region (e.g. the entire background, captured by the camera system in the monitored environment). Foreground object markers that indicate the presence of foreground objects may be superimposed. In one embodiment of the invention, only foreground object markers, but not the corresponding foreground objects themselves, are shown in the event history video. The stationary image may be a frame of the video of the monitored environment, taken at a time when no foreground objects were present in the monitored environment. The stationary image may be displayed for the entire duration of the event history video. The foreground object markers may be superimposed over the stationary image. The superimposed foreground object markers may include color shifts or blurs of color, applied to the stationary image, that indicate the presence of foreground objects in the monitored environment. Different colors may be used to represent different foreground objects. For example, the presence of a person may be encoded by a red color shift, whereas the presence of a pet may be encoded by a green color shift. Further, the intensity of the discoloration may be modulated based on the duration that a foreground object was present.

The event history video, in accordance with an embodiment of the invention, includes a series of event history video frames. Each of these event history frames is generated based on events captured in the video of the monitored environment during a particular time window. A single event history video frame may be obtained from a segment of the video of the monitored environment by applying local color shifts to the stationary image. The intensity of a color shift may be determined separately for each pixel of the single event history video frame. The color shift may be light if the corresponding foreground object, in the segment of the video of the monitored environment, only briefly occupied the region of the pixel. The color shift may be more pronounced if the foreground object occupied the region of the pixel over a prolonged time. In the single event history video frame, the foreground object may thus appear as a colored cloud, where areas in which the foreground object was present during a prolonged time may have a pronounced color shift, whereas areas in which the foreground object was rarely present may have a less visible color shift. As previously noted, different colors may be used to represent different foreground objects or classes of foreground objects. Accordingly, differently colored clouds may coexist in a single event history video frame.

A set of consecutive event history video frames may be combined into an event history video. To obtain a smooth transition between the multiple event history video frames, subsequent event history video frames may be generated from overlapping time windows of the event history video. For example, the first event history video frame may be generated from a time window that includes minutes 1-10 of the video of the monitored environment. The second frame may be generated from a time window that includes minutes 2-11 of the video of the monitored environment. The third frame may be generated from a time window that includes minutes 3-12 of the video of the monitored environment, etc. Those skilled in the art will appreciate that each time window may be of any configurable duration, and that the overlap between time windows may also be configurable. Further, cross fading may be applied to achieve a smoother transition between the event history video frames.

Consider a scenario in which the owner's dog is in the monitored environment. For most of the day, the owner's dog sleeps in one corner of the monitored environment, but occasionally the dog wakes up, goes to his food bowl in a different corner and subsequently returns to his resting corner. Assume that a single event history frame is generated from a one hour segment of the video of the monitored environment. Further assume that the dog is resting for 55 minutes, before he moves to the food bowl and stays there for the remaining five minutes. In a single event history frame, generated for a time window during which the dog is resting, a strong green color shift in the area of the resting corner indicates that the dog is resting at that location during the captured time window. In a later event history video frame, a green color shift is visible at the location of the food bowl, indicating that the dog has moved to the food bowl. Assume that multiple event history video frames are generated for consecutive 10 minute time windows. In the first five frames, an intense green color shift indicates that the dog is resting in the corner during the entire captured time windows. In the last frame, however, during which the dog spent five minutes in his resting corner and five minutes at the food bowl, an intermediate green color shift in both regions indicates that the dog spent approximately the same time in his resting corner and at the food bowl. A very light green color shift between the resting corner and the food bowl indicates the path the dog took from the resting corner to the food bowl. If the event history video frames are played back in consecutive order, a viewer may see the green color shift, representing the dog, first resting in the resting corner, and then moving over to the food bowl. To obtain an event history video where the dog's movement patterns show smoothly, overlapping consecutive five minute time windows are used rather than non-overlapping, consecutive five minute time windows. In the resulting video, the dog initially shows as a pronounced green color shift, at the location of the dog's resting corner. Eventually, during a brief transition period, some frames show the green color shift in the resting corner fade and move toward the food bowl, where the color shift intensifies again, as the dog remains at the food bowl.

FIG. 5 shows a method for enabling a user to review a previously generated event history video. The execution of the method may be initiated by a user accessing an event history video, for example, from a portable device. The user may access the event history, for example, using a smart phone or tablet application, or via a web browser.

In Step 500, a summary of the event history video is displayed to a user. The summary may be a symbolic representation of the event history video that may be displayed along with other event history videos. For example, a list of event history videos may be displayed, e.g., of an entire week, in consecutive order. The symbolic representation may be a timeline that, depending on the available space for displaying the timeline, may include text labels of event occurrences or individual video frames picked to provide a brief summary of the event occurrences in the event history video. Alternatively, the symbolic representation may be an icon and/or a text label. The symbolic representation may also be a highly downsampled event history video that may show, in a limited number of frames, events that are deemed significant. These highly downsampled videos may serve as preview videos that play back repeatedly or even continuously. The resolution of such preview videos may be reduced, thus making them suitable for presentation along with multiple other preview videos on a single screen.

In Step 502, a content selection is obtained from the user. The user may, for example, select a particular event history video for playback. The user may further select a particular segment of an event history video for playback. The selection may be made using a variety of selection criteria. For example, the selection criteria may be time, e.g., the user may select the first ten minutes of an event history video for playback. In one embodiment of the invention, a user may select segments to be played back based on the classifications of event occurrences documented by the event history video. For example, the user may select only segments for playback that are tagged as including unknown or security-relevant foreground objects. In one embodiment of the invention, foreground objects based on which a content selection may be performed include a particular person, or a particular animal, e.g. a pet, or any other foreground object of potential interest to the user. Content selection may further be performed based on classes of foreground objects. For example, the foreground object class “person” or “animal” may be selected, regardless of the detected person or animal, respectively.

In one embodiment of the invention, foreground objects, displayed in an event history video are highlighted. The foreground object may be marked by, for example, a halo. The marking of the foreground object may include color coding, for example to encode the relevance of the foreground object, which may be defined based on a perceived threat level or any other characteristic of the foreground object.

In one embodiment of the invention, the classification-based selection of segments from the event history video supports multi-camera monitoring systems. In such systems, the selection of a particular classification for playback may cause the multi-camera monitoring system to consider all occurrences of events of the specified classification, regardless of what camera system originally captured the event occurrences. Based on the detected event occurrences, an event history video that may include event occurrences captured by multiple camera systems may then be generated. The event history video may be generated either from existing single camera event history videos, or directly from the videos of the monitored environments and corresponding event tags, obtained from the camera systems of the monitoring system.

Consider for example a scenario in which a homeowner uses his multi-camera monitoring system to track the activity of a contractor while he is not at home. The contractor is authorized to perform work in the living room, but is not supposed to enter any other rooms. On the same day, the housekeeper, who is authorized to enter all rooms, is also present. Each of the rooms is equipped with a camera system in accordance with an embodiment of the invention. The multi-camera system recognizes the contractor (e.g. based on the color of his coat) and accordingly tags all segments of the videos provided by the cameras of the monitoring system, regardless of the location of the contractor. Accordingly, the monitoring system is capable of tracking the contactor within the house. The monitoring system uses a separate classification for tracking the housekeeper. When the homeowner returns and reviews the event history video, the homeowner specifies the classification used for the contractor to review the contractor's activities within the house. Based on the selected classification, all footage that shows the contractor, regardless of what camera system in what room captured the activity, is played back to the homeowner. Because a separate classification is used for the housekeeper, the monitoring system may reliably identify the presence of the contractor within a monitored environment and may avoid confusion with the housekeeper. The homeowner may thus verify whether the contractor has complied with the instructions not to enter any rooms except for the living room.

In Step 504, the selected content is played back to the user. The user may control the playback and may, for example, modulate the playback speed and may skip and or repeat sections of the selected content.

Embodiments of the invention may enable a monitoring system to generate event history summaries, i.e., video summaries of event occurrences detected in an environment secured by the monitoring system. An event history summary, in accordance with one or more embodiments of the invention enables a user of the monitoring system to rapidly review and assess event occurrences. The user may specify the relevance for individual classes of event occurrences such that the created event history summary primarily displays event occurrences that are considered relevant, while putting less emphasis on event occurrences deemed less relevant or non-relevant. An event history video may have a pre-specified length, regardless of the time span for which an event history video is to be created. Thus, regardless of whether a video is generated for a period of a few hours only, or for a period spanning multiple days, a video of the desired length may always be created. In one embodiment of the invention, the user has control over the playback of the video and may, for example, replay, or skip segments of the video and may further manipulate the playback speed as desired. In one embodiment of the invention, an event history video is generated from videos obtained from multiple camera systems monitoring multiple environments. Thus, occurrences of events may be included in the event history video, regardless of where the events occurred.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for analyzing a video captured by a security system, comprising:
obtaining the video of a monitored environment;
detecting an occurrence of an event in the video of the monitored environment, wherein detecting the occurrence of the event comprises:
identifying, in a depth data recording associated with the video, a presence of a foreground object in the video of the monitored environment, based on movement of the foreground object; and
classifying the foreground object;
tagging the occurrence of the event in the video with the foreground object classification; and
generating an event history video from the video of the monitored environment, wherein the video of the monitored environment is resampled, the resampling comprising:
applying a first frame drop rate to a segment of the video of the monitored environment that does not include the foreground object;
applying a second event-specific frame drop rate to segments of the video of the monitored environment that include the foreground object, based on the tagging,
wherein the second event-specific frame drop rate is lower than the first frame drop rate.

2. (canceled)

3. The method of claim 1, wherein the foreground object comprises a set of pixels corresponding to a moving object in the monitored environment.

4. The method of claim 1, wherein the classification of the foreground object determines a significance of the foreground object.

5. The method of claim 4, wherein the significance of the foreground object depends on the security-relevance of the foreground object.

6. The method of claim 4, wherein the second event-specific frame drop rate is determined based on the significance of the foreground object.

7. (canceled)

8. The method of claim 1, wherein the second event-specific frame drop rate is preset.

9. The method of claim 1, wherein the second event-specific frame drop rate is adapted to obtain a preset length of the event history video.

10. The method of claim 1 further comprising:
displaying a summary of the generated event history video;
receiving, from a user viewing the summary, a content selection;
isolating portions of the event history video based on the content selection; and
displaying the isolated selected content to the user.

11. The method of claim 10, wherein the content selection is a time interval of the event history video.

12. The method of claim 10, wherein the selected content is a specific foreground object.

13. The method of claim 12, wherein the specific foreground object is one selected from a group consisting of a person and an animal.

14. The method of claim 12, wherein the specific foreground object is highlighted.

15. The method of claim 12, further comprising, prior to displaying the isolated selected content to the user:
generating a second event history video of a second monitored environment, wherein the second monitored environment comprises the specific foreground object;
isolating the specific foreground object in the second event history video; and
adding the isolated specific foreground object in the second event history video to the isolated selected content.

16. A method for analyzing a video captured by a security system, comprising:
obtaining the video of a monitored environment;
detecting an occurrence of an event in the video of the monitored environment, wherein detecting the occurrence of the event comprises:
identifying the presence of a foreground object in the video of the monitored environment;
classifying the foreground object; and
generating an event history video from the video of the monitored environment, comprising:
generating a set of frames of the event history video,
wherein each frame of the event history video comprises a background region;
wherein each frame of the event history video corresponds to a time window of the video of the monitored environment; and
wherein, in at least a frame of the set of frames, a color shift is applied to a portion of the pixels of the frame that are in a region of the frame in which the foreground object was present in the video of the monitored environment during the time window corresponding to the frame; and
wherein the foreground object is not shown in the frame.

17. The method of claim 16, wherein the color shift is of a color that is specific to the foreground object.

18. The method of claim 16, wherein an intensity of the color shift is modulated by a duration the foreground object was present in the video of the monitored environment, during the corresponding time window.

19. The method of claim 16, wherein consecutive frames of the event history video represent consecutive time windows of the video of the monitored environment.

20. The method of claim 19, wherein the consecutive time windows of the video of the monitored environment overlap.

21. A non-transitory computer readable medium comprising instructions that enable a system to:
obtain a video of a monitored environment;
detect an occurrence of an event in the video of the monitored environment,
wherein detecting the occurrence of the event comprises:
identifying, in a depth data recording associated with the video, a presence of a foreground object in the video of the monitored environment; and
classifying the foreground object;
tag the occurrence of the event in the video with the foreground object classification; and
generate an event history video from the video of the monitored environment,
wherein the video of the monitored environment is resampled, the resampling comprising:
applying a first frame drop rate to a segment of the video of the monitored environment that does not include the foreground object;
applying a second event-specific frame drop rate to segments of the video of the monitored environment that include the foreground object, based on the tagging,
wherein the second event-specific frame drop rate is lower than the first frame drop rate.

22. The non-transitory computer readable medium of claim 21, wherein the classification of the foreground object determines a significance of the foreground object.

23. The non-transitory computer readable medium of claim 22, wherein the second event-specific frame drop rate is determined based on the significance of the foreground object.

24. The non-transitory computer readable medium of claim 21 further comprising instructions that enable the system to
display a summary of the generated event history video;
receive, from a user viewing the summary, a content selection;
isolate portions of the event history video based on the content selection; and
display the isolated selected content to the user.

25. The non-transitory computer readable medium of claim 24, wherein the selected content is a specific foreground object.

26. The non-transitory computer readable medium of claim 25, further comprising instructions that enable the system to, prior to displaying the isolated selected content to the user:
generate a second event history video of a second monitored environment, wherein the second monitored environment comprises the specific foreground object;
isolate the specific foreground object in the second event history video; and
add the isolated specific foreground object in the second event history video to the isolated selected content.

27. A non-transitory computer readable medium comprising instructions that enable a system to:
obtain a video of a monitored environment;
detect an occurrence of an event in the video of the monitored environment, wherein detecting the occurrence of the event comprises:
identifying the presence of a foreground object in the video of the monitored environment;
classifying the foreground object; and
generate an event history video from the video of the monitored environment, comprising:
generating a set of frames of the event history video,
wherein each frame of the event history video comprises a background region;
wherein each frame of the event history video corresponds to a time window of the video of the monitored environment; and
wherein, in at least a frame of the set of frames, a color shift is applied to a portion of the pixels of the frame that are in a region of the frame in which the foreground object was present in the video of the monitored environment during the time window corresponding to the frame; and
wherein the foreground object is not shown in the frame.

28. The non-transitory computer readable medium of claim 27, wherein the color shift is of a color that is specific to the foreground object.

29. The non-transitory computer readable medium of claim 27, wherein an intensity of the color shift is modulated by a duration the foreground object was present in the video of the monitored environment, during the corresponding time window.

30. The non-transitory computer readable medium of claim 27, wherein consecutive frames of the event history video represent consecutive time windows of the video of the monitored environment.
